(19) United States
(12) Patent Application Publication
(10) Pub. No.: US 2015/0213147 A1
(43) Pub. Date: Jul. 30, 2015

(54) Content remixing

(71) Applicants: Brian Riggs, San Francisco, CA (US); Darrick P. Brown, Redwood City, CA (US); Daniel J. Cooley, San Francisco, CA (US)

(72) Inventors: Brian Riggs, San Francisco, CA (US); Darrick P. Brown, Redwood City, CA (US); Daniel J. Cooley, San Francisco, CA (US)

(73) Assignee: Adobe Systems Incorporated

(21) Appl. No.: 11/486,337

(22) Filed: Jul. 13, 2006

(51) Int. Cl. G06F 17/30; G06F 17/21; G06F 17/22

(52) U.S. Cl. CPC G06F 17/30896; G06F 17/2247; G06F 17/212

(57) ABSTRACT

Content remixing is described, including retrieving content from a first location using an application, the content being non-modifiable at the first location, remixing the content using the application, the content being modifiable after being retrieved by the application, wherein editing the content comprises augmenting the content with other content to generate new content, and publishing the new content to the second location using the application, the new content being accessible after being saved to the second location.

### FIELD OF THE INVENTION

The present invention relates generally to software applications and architecture. More specifically, content remixing is described.

### BACKGROUND OF THE INVENTION

Publishing and editing content to various sources on the Internet and World Wide Web (“web”) is a growing, widespread, and popular activity. Content (e.g., text, images, video, audio, multimedia, and others) can be published using various types of conventional applications and techniques. However, the wide range of data communication protocols (“protocols”), formats, syntax, and other standards by which content is transmitted, handled, edited, or published often make content publishing and editing techniques difficult using conventional techniques.

In some conventional techniques, content is published to web logs or “blogs,” which are individual postings of content. Blog content or blogs are often created using conventional techniques that often require using multiple applications throughout the content editing process. Further, there are numerous different and non-standardized applications available for various parts of the content publishing and editing process. Still further, different content formats (e.g., RSS (“Really Simple Syndication,” “Rich Site Summary,” “Resource Description Framework (RDF) Site Summary,” or the like), HTML, XML, and others), syntax, and protocols (e.g., HTTP, XMPP, and others) have resulted in many different applications for content publishing and editing. Conventional content editing applications can receive updated content (e.g., a blog editing application can receive updates if other authors have posted to the same blog). However, conventional content editing applications are generally not capable of receiving updated, non-modifiable content that can subsequently be published to a writable endpoint. Another problem is conventional publishing and editing applications are not configured to retrieve and display updated content (e.g., updated news articles provided using RSS feeds) that can be modified (i.e., edited) during the editing process. This precludes enabling a user to combine updated content with other original content to generate a blog posting, article, or other new content. Yet another problem is that conventional techniques often require users to work with several, different locations for data and files. Working with multiple locations creates a difficult and burdensome user experience, requiring users to close or minimize interfaces and to open other interfaces to retrieve, copy, save, edit, or otherwise work with content. Multiple types of content may also require working with different applications. Given the widespread evolution of the types of content and various formats, syntax, and protocols that exist for publishing and editing content, conventional techniques are inefficient and inadequate.

Thus, a solution for publishing and editing content without the limitations of conventional techniques is needed.

### BRIEF DESCRIPTION OF THE DRAWINGS

Various examples are disclosed in the following detailed description and the accompanying drawings:

FIG. 1 illustrates an exemplary content remixing system;

FIG. 2 illustrates an exemplary content remixing application;

FIG. 3A illustrates an exemplary retrieval module;

FIG. 3B illustrates an exemplary parsing/normalization module;

FIG. 3C illustrates an exemplary display module;

FIG. 3D illustrates an exemplary editing module;

FIG. 3E illustrates publishing module;

FIG. 4 illustrates an exemplary process for content remixing;

FIG. 5 illustrates an alternative exemplary process for content remixing; and

FIG. 6 illustrates an exemplary computer system suitable for content remixing.

### DETAILED DESCRIPTION

Various embodiments or examples may be implemented in numerous ways, including as a system, a process, an apparatus, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided as examples and the described techniques may be practiced according to the claims without some or all of the accompanying details. For clarity, technical material that is known in the technical fields related to the embodiments has not been described in detail to avoid unnecessarily obscuring the description.

Content remixing is described, including various techniques for retrieving content from one or more sources into an application configured to receive, display, view, edit, and publish content. An editing application may be configured for various types of formats, syntax, and protocols for publishing and editing content. In some examples, content remixing may refer to publishing and editing different types of content from various sources using a single application to retrieve, parse or normalize, display, edit, and publish content. In other examples, content remixing may be implemented differently and is not limited to the various examples provided and described.

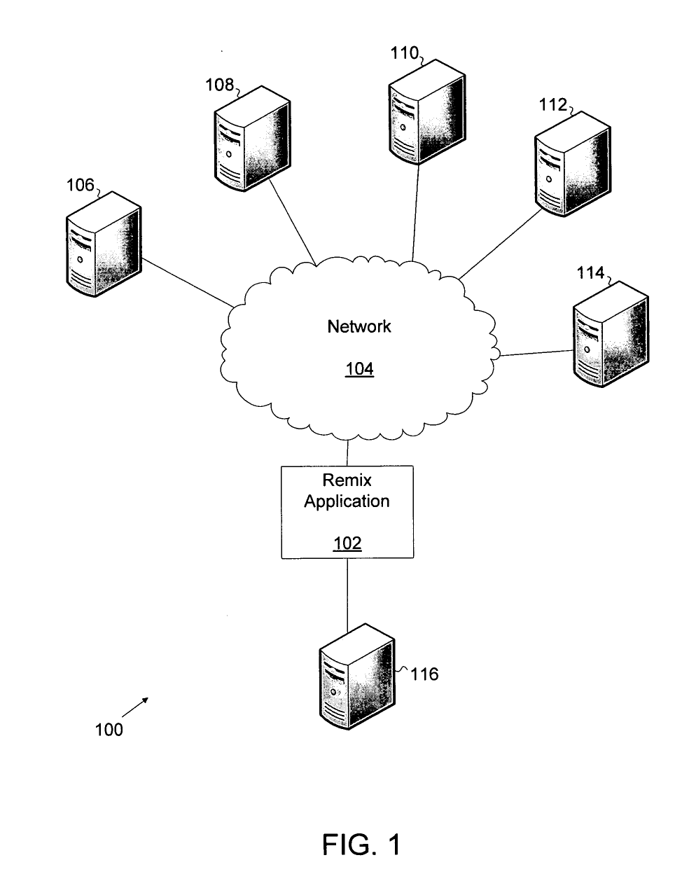

FIG. 1 illustrates an exemplary content remixing system. Here, system 100 includes remix application 102, network 104, and processors 106-116. In some examples, remix application 102 may be implemented as a computer program, software, or application (“application”) on a computer, server, or other type of processor (“processor”), such as processors 106-116. Remix application 102 may be implemented using various types of programming or formatting languages, formats, syntax, and protocols, including C, Objective C, C++, C#, Java, COBOL, Fortran, ADA, XML, HTML, XHTML, HTTP, XMPP, and others. The types of programming or formatting languages, formats, syntax, and protocols used are not intended to be limited and various types may be used.

Remix application 102 may be implemented as a standalone application or as part of another application. In some examples, remix application 102 may also be implemented as a single application or multiple applications, providing different modules for various types of functionality. Plug-ins (not shown) may be implemented as application programming interfaces (APIs) to also allow for additional or different functionality to be implemented with remix application 102 and system 100. Remixing application 102 may be implemented to provide the content remixing techniques described herein as part of another publishing or editing application. In other examples, remix application 102 may be implemented differently.

Here, network 104 may be a public or private network, including the Internet, a local area network (LAN), a wide area network (WAN), a municipal area network (MAN), or other network using a different topology other than those described above. In some examples, network 104 may be implemented as the Internet with various types and numbers of data sources (“sources”) from which content may be retrieved (i.e., “downloaded”) or saved (i.e., “uploaded”).

In some examples, processors 106-116 may be implemented using various types of computers (e.g., laptops, notebooks, desktop, pen computing, personal digital assistants, smart phones, mobile and handheld devices, and others), servers, or processing devices. Here, one, some, or all of processors 106-116 may represent content, application, web, or other types of servers that render content available for various purposes. As an example, processor 106 may be a server that provides content for a website affiliated with a popular national news network. Content that can be downloaded, retrieved, or fed (i.e., using syndication formats such as RSS, XML, or others) from processor 106 may be retrieved by one or more of processors 108-116 and used, when mixed with other content, to publish new content. By using remix application 102, new content may be generated using a single application that retrieves content from various and multiple types of sources (i.e., processors 106-114). In other examples, system 100 may be implemented differently and is not limited to the examples provided above.

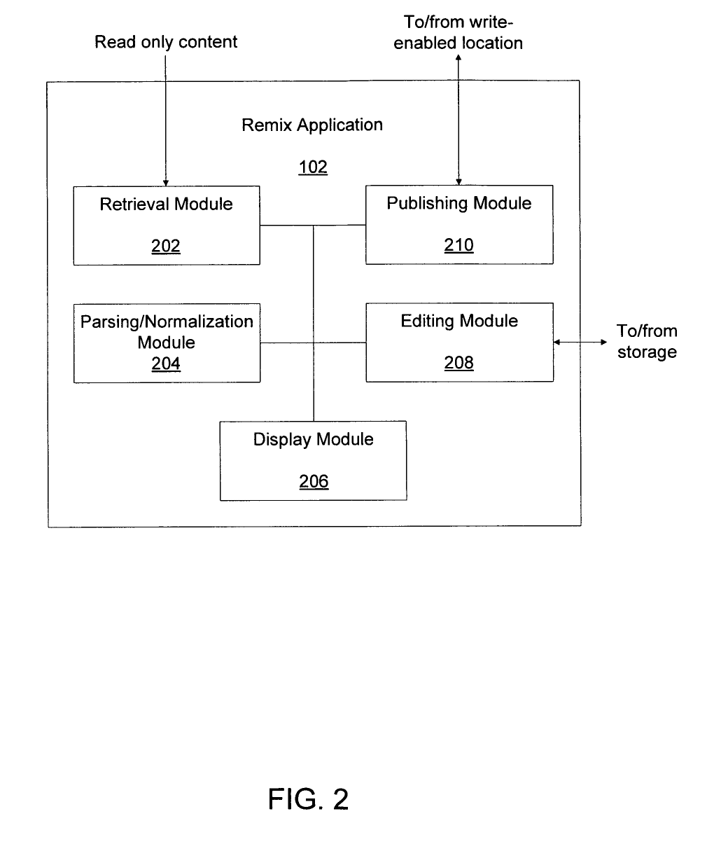

FIG. 2 illustrates an exemplary content remixing application. Here, remix application 102 is shown in greater detail, including retrieval module 202, parsing/normalization module 204, display module 206, editing module 208, and publishing module 210. The illustrated modules may be varied in design, implementation, and number and are not limited to the examples and descriptions provided. In some examples, remix application 102 is configured to retrieve content from various sources. Different sources (e.g., processors 106-114) may provide different types of content (e.g., text, images, video, audio, and others) to remix application 102, which may be configured to retrieve content from a read-only source (i.e., a source, location, or processor that does not allow remix application 102 to modify content at the source, location, or processor) format from a location (e.g., a server on the Internet) or source (“source”). Once retrieved, local copies of the content may be converted or transformed into a modifiable format and edited using remix application 102. As an example, a copy of the content retrieved from the front page of cnn.com may be saved to a local file on a computer after which changes to the content in that local file may be made. Content located on a read-only source cannot be modified (i.e., content on cnn.com cannot be modified on processors serving cnn.com content).

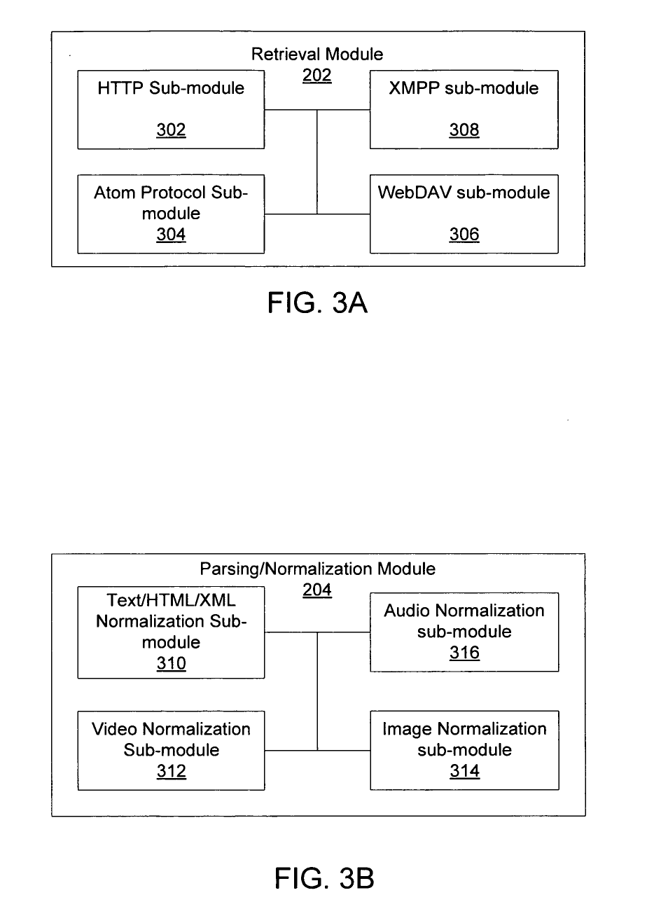

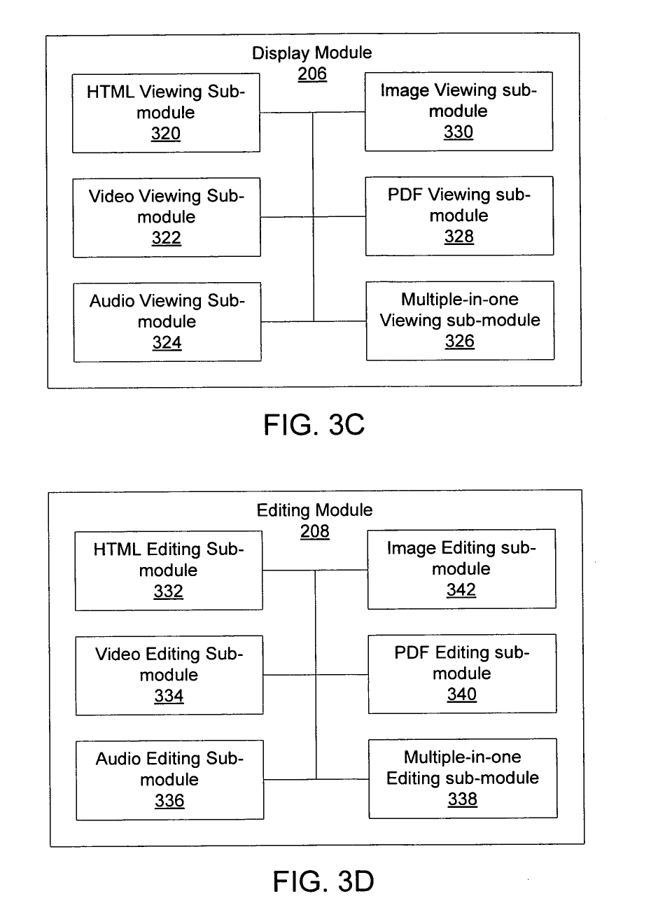

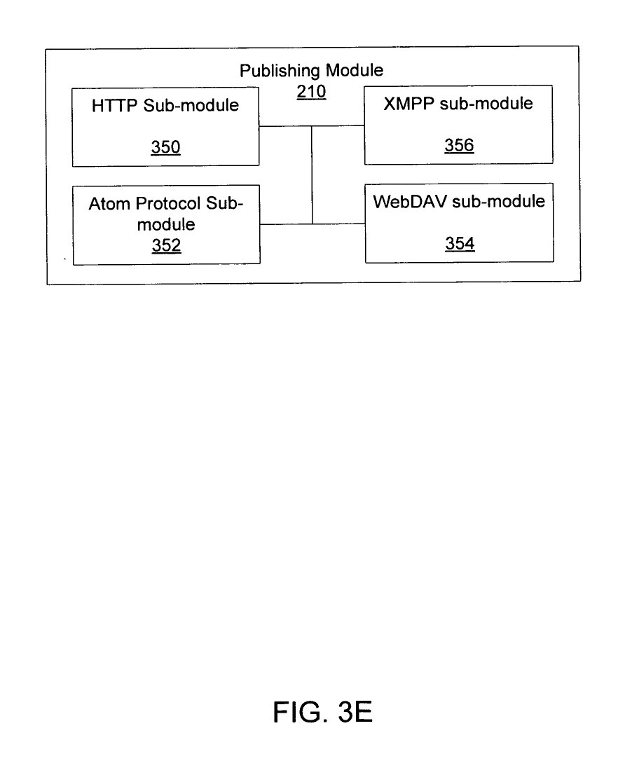

In some examples, retrieval module 202 may be implemented as part of remix application 102 and used to retrieve content from a source. A source may be a server located on the Internet (e.g., processors 106-114, FIG. 1) that provides content, such as HTML-formatted content (e.g., text, images, video, audio, and others). Content may be retrieved in a read-only or modifiable format. Content may also be “pulled’ into remix application 102 by retrieval module 202 automatically or manually. In other words, a user may identify content at a location to use for remixing with other content. For example, a blogger (i.e., an entity, system, application, or individual that creates, edits, or maintains web logs) may identify an RSS feed from a major news network's website for use with her blog. The content may be manually identified and then, using retrieval module 202, brought in as a feed or fed to remix application 102. Retrieval module 202 may also be configured with one or more sub-modules for handling various types of content, formats, syntax, and protocols, as described below in connection with FIG. 3A.

Referring back to FIG. 2, after retrieving content, retrieval module 202 may pass content to parsing/normalization module 204, which may be configured to parse or normalize data associated with the content (e.g., text data, image data, video data, audio data, and the like). Data may be analyzed using a variety of techniques such as vector, image, or graphical analysis to normalize the data for use with other features of remix application 102, which may include further editing and publishing of the content, transforming normalized data into formats for use, for example, with web browsers and other applications configured for viewing. Any type of normalization process or technique may be used and the described techniques are not intended to be limited to the examples provided. In some examples, display module 206 may be configured to provide features and functions to enable viewing of content using remix application 102. For example, display module 206 may be configured to present (i.e., render and display) content using a portable document viewer in order to render and display content in portable document format (PDF), such as that developed by Adobe Systems Incorporated of San Jose, Calif. In other examples, display module 206 may be configured to present content in other viewable formats, including video, images, text, and others. In other examples, display module 206 may also be used to render non-visual (e.g., images, video, text) content such as audio, presenting audio-based content through a media or audio player application that is either part of or separate from remix application 102.

In some examples, content may be edited using editing module 208. Editing module 208 may be configured to allow editing of content in various forms, including HTML, XML, and others. Remix application 102 may be used to edit retrieved content with other content that may be retrieved from another source (e.g., local storage, cache, or other location). For example, a news blog may be constructed using an RSS feed of updated news content and other, originally-authored content (e.g., a news commentary or article created by a user of remix application 102 (i.e., a blogger)) using editing module 208. Editing module 208 may also be used to author new content without the use of retrieved content from other sources. In still other examples, editing module 208 may also be used to edit text (e.g., selecting a cite or section of an overall larger article), image (e.g., cropping or rotating an image for presentation with content published using remix application 102), video (e.g., selecting a desired portion of a timeline of a downloaded news video clip from another location), audio (e.g., identifying a discrete portion of a sound recording for audio playback from new content that is published using remix application 102), or other content. In addition to editing the appearance, rendering, display, or playback of content, editing module 208 may also be used to specify parameters, characteristics, or other settings. For example, settings may be specified for remixed content to allow playback of video and audio content through a media player, instead of a web browser. Likewise, parameters may be specified that determine how an image is rendered in a browser, including the size, area, layout, style, or colors of an image. In other examples, different editing features and functions for different types of content may be performed and are not limited to the examples provided above.

After remixing desired content, publishing may be performed using publishing module 210. In some examples, publishing module 210 may be configured to handle content using various formats, syntax, and protocols. In other examples, publishing module 210 may be configured to handle formats similar to those handled by retrieval module 202. In still other examples, publishing module 210 may be configured to communicate data from remix application 102 through a communication interface module (not shown), that also acts as a communication interface for retrieval module 202. Here, publishing module 210 may be configured with a communication interface and used to publish remixed content to a location (e.g., a write-enabled (i.e., having permissions or rights to access and modify content) server on the Internet, web, LAN, or other network). Publishing module 210 may also be used to publish content to a location, providing parameters, characteristics, and other settings (e.g., those determined using editing module 208) that are used to determine how content is presented (e.g., displayed, played, viewed, accessed, retrieved) when accessed. Publishing module 210 may also be used to ensure that content is presented in substantially the same appearance as presented by remix module 102 (i.e., display module 206) if a what-you-see-is-what-you-get (WYSIWYG) editor is used. In other words, if a WYSIWYG editor is used with remix application 102, then content, when published, should appear substantially similar to the manner in which it was presented by remix application 102. The above-described system 100 and its associated elements may be varied and are not limited to the examples provided above. More, fewer, or different elements may be implemented and are also not limited in design, function, or implementation to the examples described above.

FIG. 3A illustrates an exemplary retrieval module. Here, retrieval module 202 is shown with several sub-modules, including HTTP sub-module 302, Atom protocol sub-module 304, XMPP sub-module 306, and webDAV sub-module 308. Retrieval module 202 is configured to handle various types of formats, syntax, and protocols for content. Sub-modules 302-308 are not intended to be all-inclusive nor comprehensive of the various types of formats, syntax, and protocols of content that may be used by retrieval module 202 and, in turn, remix application 102. In some examples, content may be retrieved using communications protocols (e.g., HTTP, RSS, XML (including XML and HTTP-based variants such as XMPP), IP, UDP, TCP, and others) that determine how associated data should be transmitted. Protocols such as HTTP, Atom, XMPP, and others may also be handled using sub-modules 304-308. When content is retrieved from a source (e.g., a read-only server located on the Internet), sub-modules 302-308 retrieve data using the type of data communication protocol associated with the desired content. Data communication protocols may be used to determine how data packets, segments, frames, and the like are interpreted and handled. Header, footer, and payload data are interpreted using one or more of sub-modules 302-308, which may be supplemented, complemented, or replaced with other sub-modules in order to support different protocols other than those described. Further, application programming interfaces (APIs) may be provided to allow for “off-the-shelf” or third-party applications to be used in order to support protocol interpretation techniques beyond those described herein. Here, retrieval module 202 may be configured to handle any type of communication protocol for use when retrieving content. In other words, more, fewer, or different sub-modules other than those shown and described may be used. In other examples, retrieval module 202 may be configured differently and is not limited in design, function, or implementation to the examples provided above.

FIG. 3B illustrates an exemplary parsing/normalization module. Here, parsing/normalization module 204 includes text/HTML/XML normalization sub-module 310, video normalization sub-module 312, image normalization sub-module 314, and audio normalization sub-module 316. In some examples, sub-modules 310-316 may be used to parse data from content retrieved from a source. Once retrieved and parsed, the content data may be normalized, for example, to assign values to content that is later used to transform the content for use (i.e., editing and publishing) by remix application 102. In other words, data associated with retrieved content may be normalized to allow remix application to edit and publish new content including the retrieved content, which uses normalized data to determine how to render, present, display, or publish new or remixed content. In other examples, more, fewer, or different sub-modules may be used in parsing/normalization module 204 and are not limited to the examples provided. Further, parsing/normalization sub-module 204 is not limited in design, function, or implementation to the examples provided and described above.

FIG. 3C illustrates an exemplary display module. Here, display module 206 is shown with HTML viewing sub-module 320, video viewing sub-module 322, audio viewing sub-module 324, multiple-in-one viewing sub-module 326, PDF viewing sub-module 328, and image viewing sub-module 330. In some examples, HTML viewing sub-module 320 may be used to present HTML-formatted content. Likewise, video viewing sub-module 322 may be used to present video content. Audio viewing sub-module 324 may be used to present audio-based forms of content, including music, songs, voice, and other sound or audio recordings. Multiple-in-one viewing sub-module 326 may be used to present content in multiple formats, but in a single interface or display. For example, an editing application using remix application 102 (FIG. 1) may retrieve several forms of content, all, some, or none of which may be displayed within a single user interface. In some examples, different types of content may be displayed using multiple-in-one viewing sub-module 326, which may be configured to render digital data associated with text, images, video, and audio content. The content may be provided in order to allow a user to view, edit, or remix various types of content together. For example, a user may want to provide video and text content remixed with a musical score or other type of background audio. As another example, video and audio data may be remixed to display an image of a person, but with another person's voice. Multiple-in-one viewing sub-module 326 may be varied in design, function, and implementation and is not limited to the examples provided above.

In other examples, PDF viewing sub-module 328 may be used to present content in a portable document format, such as that developed by Adobe Systems Incorporated of San Jose. Other types of document, image, or data formats may be handled by PDF viewing sub-module 328 and are not limited to the examples provided. Here, PDF viewing sub-module 328 may interpret and present data associated with a document that is retrieved from a content source using retrieval module 202. Content may be in a document format and, in some examples, in a read-only format. However, when a “user gesture” (e.g., clicking on an icon or other graphical element in an interface to save, cache, or the like) is performed on a document using remix application 102 (FIG. 1), content may be transformed into a modifiable format. In some examples, caching or local storage may be performed if remix application 102 is used in an offline (i.e., disconnected from a network, the Internet, or web) mode. In other examples, caching or local storage may also be performed to provide a local copy of retrieved content that may be modified, supplemented, deleted, or otherwise edited (i.e., transformed into a modifiable format). When displaying content in a document format (e.g., PDF, Word, or others), PDF viewing sub-module 328 renders and presents the document or data in remix application 102 (FIG. 1). In some examples, PDF viewing sub-module 328 may launch another application within a window, pane, or frame within an interface presented by remix application 102, thus allowing the document to be viewed within a single application. Thus, multiple applications are not required for viewing disparate types of content. PDF viewing sub-module 328 may be replaced, supplemented, or complemented with other sub-modules or plug-ins to other types of data and document formats that allow remix application 102 to present data without using different applications and user interfaces.

In still other examples, imaging viewing sub-module 330 may be provided. In addition to displaying text, video, and audio, graphics and images may also be displayed. Imaging viewing sub-module 330 may be used to interpret and render data associated with various images, providing information such as pixel count and position in order to generate a display of an image on an interface for remix application 102. In other examples, imaging viewing sub-module 330 may also be used or implemented differently. Sub-modules 320-330 may be implemented differently, with other functions or features supplement, complementing, or replacing those described above. Further, sub-modules 320-330 may be configured to exchange data and are not limited to any particular data communication path or technique for exchanging data associated with retrieved content.

FIG. 3D illustrates an exemplary editing module. Here, editing module 208 includes several sub-modules including HTML editing sub-module 332, video editing sub-module 334, audio editing sub-module 336, multiple-in-one editing sub-module 338, PDF editing sub-module 340, and image editing sub-module 342. Several different types and forms of content may be edited in remix application 102 by using editing sub-module 208. Sub-modules 332-342 provide editing capabilities that may be presented through an associated user interface to allow manual, semi-automatic, or automatic (i.e., system-specified) editing of content. In some examples, content retrieved using retrieval module 202 is transformed from a read-only to a modifiable state by saving a copy of the content and presenting it in a display or interface associated with remix application 102. In the same interface (not shown) for remix application 102, other content of various types and formats may be displayed and combined with the retrieved content to create new content. For example, a blog may be created from read-only content found on another blog and remixed with content created by a user of remix application 102. The read-only content may be video and audio data of a posted commentary, but the user may wish to append or provide commentary to create new content. The new content may then be uploaded or saved to a “write-enabled” server or other location that allows the user to save new content and provide public (or private) access to it. In other examples, other “off-the-shelf” or “turn-key” content editors or sub-editors (e.g., editing applications integrated or coupled to remix application 102) may be used with remix application 102 by integrating with one or more of sub-modules 332-342. Integration may be performed by providing a “plug-in” or application programming interface to one or more of sub-modules 332-342. Further, the number and type of sub-modules provided in editing module 208 may be varied and are not limited to the examples provided above.

FIG. 3E illustrates publishing module. Here, publishing module 210 may include sub-modules for publishing content using various protocols, including HTTP sub-module 350, Atom protocol sub-module 352, webDAV sub-module 354, and XMPP sub-module 356. The number and type of sub-modules provided may be varied and are not limited to the examples described. For example, publishing module 210 may be implemented with other sub-modules used to publish content using other formats and protocols in addition to those illustrated. In other examples, one or more of sub-modules 350-356 may be replaced with different sub-modules designed to handle protocols beyond HTTP, Atom publishing, webDAV, or XMPP. Other protocols such as other HTTP, Atom publishing, XMPP, or other HTTP-based variants may be used to publish new (i.e., remixed) content using remix application and publishing module 210 by implementing other sub-modules in addition to those shown. Further, any type of format, syntax, or protocol may be used and the above-described modules and sub-modules may be varied in design, function, or implementation to support these variations. Still further, the various modules and sub-modules have been described using various examples, but other examples and configurations, including exchanging data between modules 202-210 and sub-modules 302-356 may be performed using any type of layout, configuration, or function. In some examples, modules 202-210 and sub-modules 302-356 may be implemented as software, application, or program code, using one or more of various formatting and programming languages such as those described above. In other examples, modules 202-210 and sub-modules 302-356 may be implemented differently, including using software, hardware, firmware, circuitry, or a combination thereof. Modules 202-210 and sub-modules 302-356 are examples for implementing the above-described techniques, but more, fewer, or different sub-modules may be used, including using APIs or other “plug-in” modules or sub-modules.

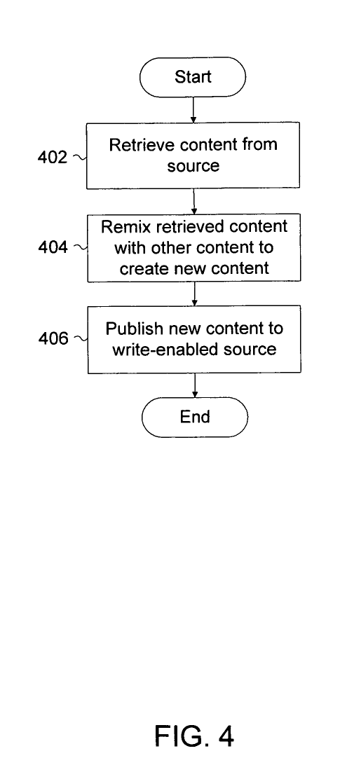

FIG. 4 illustrates an exemplary process for content remixing. Here, content is retrieved from a source (402). In some examples, retrieved content may be retrieved from a read-only source, location, processor, or other resource. Content may be non-modifiable at the read-only source, location, processor, or other resource when accessed using the techniques described herein. However, when retrieved and stored locally, content may be transformed into a modifiable state, permitting modification, editing, and publishing of the retrieved content. In some examples, content may be digitally right protected, but other content may be retrieved from read-only sources, locations, processors, or resources and, once saved locally, transformed into a modifiable version that may be edited using remix application 102. Once retrieved, content and associated data may be modified and manipulated. In other examples, retrieved content may be accessed in a modifiable state. In some examples, content may be saved or cached locally and a “user gesture” (e.g., clicking on a disk icon to perform a save or caching function) may be performed to initiate saving the content and transforming it to a modifiable state. If the content is retrieved from a read-only source, location, processor, or resource, then the content may be saved or cached locally to create a modifiable version of the content that may be remixed with other content or edited. In some examples, performing a save or local caching function without a transformation of the content to a modifiable state (i.e., the content was retrieved in a modifiable state) reduces time delays and power and processor requirements. After saving the content, other content may be remixed with the saved or cached content to create new content (404). In some examples, new content may be generated by remixing text, images, documents, video, audio, multi-media, or other forms of content. New content may also be generated by creating new text, images, documents, video, audio, multi-media, or other forms of content. New content may be published to a write-enabled location after remixing is performed (406). In some examples, publishing new content to a write-enabled location may include saving the new content to a destination linked to a uniform resource indicator or location (URI or URL) to allow other users to access the content. New content may be saved to a write-enabled location, which may be determined by a user or system-set by remix application 102. Other variations for saving content to a write-enabled location may be performed and is not limited to the techniques described above. Further, the above-described process may be varied to include more, fewer, or different processes or sub-processes and is not limited to the examples described.

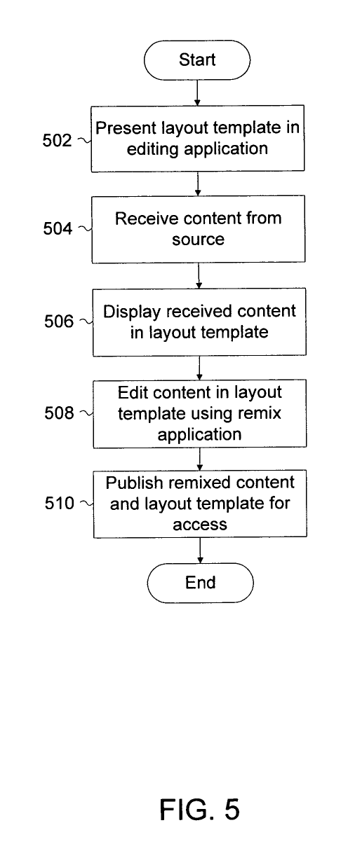

FIG. 5 illustrates an alternative exemplary process for content remixing. Here, a layout template is provided in an editing application that may include remix application 102 (FIG. 1) (502). Content may be retrieved from a source and received in the layout template (504). The retrieved content may be displayed in the layout template in, for example, a user interface or display associated with remix application 102 (506). Once displayed in the layout template, retrieved content may be edited or remixed with other content to generate new content (508). In some examples, the layout template may provide various layouts, styles, formats, or other parameters or characteristics that are used to determine how content is displayed when accessed, either in an interface associated with remix application 102 or from a server, computer, processor, memory, or other location that is accessible. After remixing, new content may be published to a write-enabled location that is configured for public or private (i.e., secure, encrypted, password-protected, or otherwise non-publicly accessible) access (510). In other examples, the above-described process may be varied and is not limited to the examples provided. For example, remix application 102 may be implemented as a WYSIWYG editor and content is edited, published, and accessed with substantially the same “look-and-feel,” appearance, or user experience. As another example, new content may be generated by retrieving content from a read-only source and publishing the content to a new location, digital rights management issues (e.g., copyright) notwithstanding. Functionally, the above-described process may be varied by providing different types of layout templates that may be pre-determined or pre-defined based upon remix application 102, the type of content being edited, contextual themes (e.g., a news blog, a sports website, a corporate extranet's homepage, and others), or other factors that may be varied beyond the examples provided above. In still other examples, the above-described process may be further varied in processes or sub-processes and is not limited to the examples provided above.

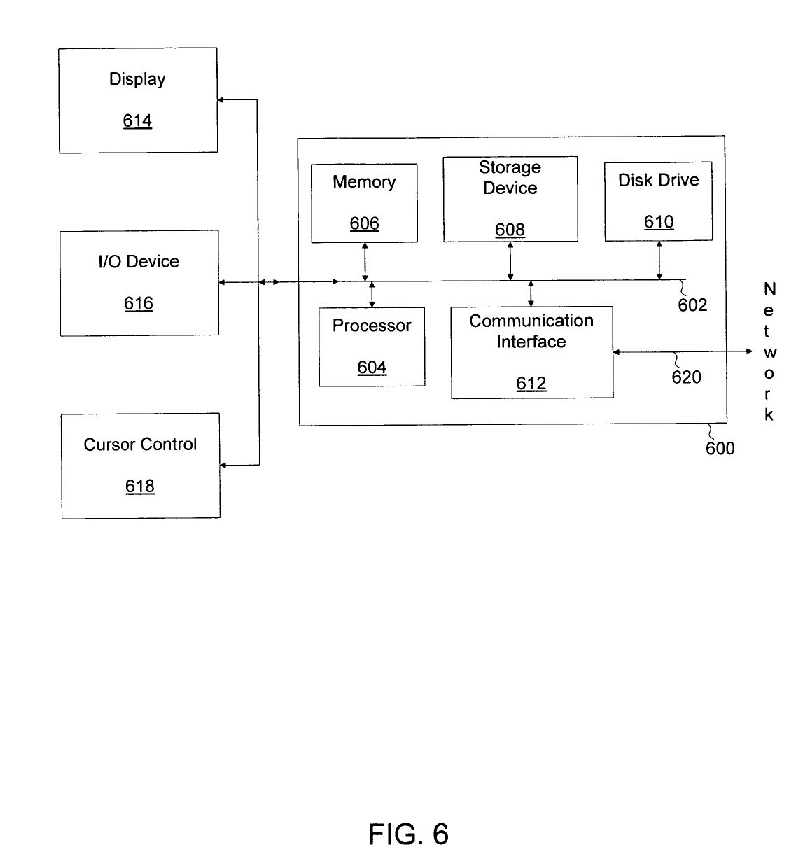

FIG. 6 illustrates an exemplary computer system suitable for content remixing. In some examples, computer system 600 may be used to implement computer programs, applications, methods, processes, or other software to perform the above-described techniques. Computer system 600 includes a bus 602 or other communication mechanism for communicating information, which interconnects subsystems and devices, such as processor 604, system memory 606 (e.g., RAM), storage device 608 (e.g., ROM), disk drive 610 (e.g., magnetic or optical), communication interface 612 (e.g., modem or Ethernet card), display 614 (e.g., CRT or LCD), input device 616 (e.g., keyboard), and cursor control 618 (e.g., mouse or trackball).

According to some examples, computer system 600 performs specific operations by processor 604 executing one or more sequences of one or more instructions stored in system memory 606. Such instructions may be read into system memory 606 from another computer readable medium, such as static storage device 608 or disk drive 610. In some examples, hard-wired circuitry may be used in place of or in combination with software instructions for implementation.

The term “computer readable medium” refers to any medium that participates in providing instructions to processor 604 for execution. Such a medium may take many forms, including but not limited to, non-volatile media, volatile media, and transmission media. Non-volatile media includes, for example, optical or magnetic disks, such as disk drive 610. Volatile media includes dynamic memory, such as system memory 606. Transmission media includes coaxial cables, copper wire, and fiber optics, including wires that comprise bus 602. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some examples, execution of the sequences of instructions may be performed by a single computer system 600. According to some examples, two or more computer systems 600 coupled by communication link 620 (e.g., LAN, PSTN, or wireless network) may perform the sequence of instructions in coordination with one another. Computer system 600 may transmit and receive messages, data, and instructions, including program, i.e., application code, through communication link 620 and communication interface 612. Received program code may be executed by processor 604 as it is received, and/or stored in disk drive 610, or other non-volatile storage for later execution.

The foregoing examples have been described in some detail for purposes of clarity of understanding, but are not limited to the details provided. There are many alternative ways and techniques for implementation. The disclosed examples are illustrative and not restrictive.

1. A computer-implemented method for remixing website content, the method comprising:
retrieving, by a remixing application executing on a computing device, website content from a plurality of sources remote from the computing device, wherein settings for the content prevent the computing device and the remixing application from modifying the content at each of the plurality of sources;
creating a modifiable copy of the retrieved content, wherein the creating comprises combining, parsing and normalizing the retrieved content;
storing the modifiable copy of the retrieved content in a computer readable storage medium remote from the plurality of sources;
remixing, by the remixing application, the copy of the retrieved content, wherein the remixing comprises editing the copy of the retrieved content and augmenting the copy of the retrieved content with other content to generate new content;
determining, by the remixing application, settings for the new content, the settings including access permissions and display parameters specifying how the new content is to be accessed and displayed; and
publishing, by the remixing application, the new content to a write-enabled destination server remote from the plurality of sources so that the new content is accessible in accordance with the access permissions and displayable in accordance with the display parameters after it has been saved to the destination server.

2. The method recited in claim 1, wherein the new content is formatted using one or more of Really Simple Syndication, Rich Site Summary, and Resource Description Framework Site Summary (RSS).

3. The method recited in claim 1, wherein the copy of the retrieved content is remixed using an editing module of the remixing application.

4. The method recited in claim 1, wherein the new content is formatted using an XML-based format.

5. The method recited in claim 1, further comprising using a publishing module of the remixing application to publish the new content to the second location.

6. The method recited in claim 1, wherein publishing the new content to the destination server further comprises formatting the new content using an XML-based format.

7. The method recited in claim 1, wherein:
the new content includes text data; and
the display parameters control how the text data can be displayed at the destination server.

8. The method recited in claim 1, wherein:
the new content includes one or more images; and
the display parameters specify, for each of the one or more images, one or more of an image size, an area, an image layout, an image style, and image colors.

9. The method recited in claim 1, wherein:
the new content includes video data; and
the display parameters specify that the video data is displayable using a media player.

10. The method recited in claim 1, wherein:
the new content includes audio data; and
the display parameters specify that the audio data can be accessed using a media player.

11. The method recited in claim 1, wherein the retrieved content and the other content are different.

12. The method recited in claim 1, wherein the plurality of sources include a read-only server.

13. The method recited in claim 1, wherein the destination server is a write-enabled server.

14. The method recited in claim 1, wherein publishing the new content to the destination server is performed using a protocol.

15. (canceled)

16. A computer-implemented method for remixing website content, the method comprising:
presenting a layout template in an editing application executing on a computing device, wherein the editing application is configured to remix website content;
retrieving website content from a plurality of servers remote from the computing device, wherein settings for the content prevent the editing application and the computing device from modifying the content at each of the plurality of servers;
creating a modifiable copy of the retrieved content, wherein the creating comprises combining, parsing and normalizing the retrieved content;
receiving the modifiable copy of the retrieved content in the layout template, the layout template being configured to edit the received content;
displaying the received content within the layout template;
remixing the received content to generate new content, wherein the remixing is performed by the editing application;
determining, by the editing application, settings for the new content, the settings including access permissions and display parameters specifying how the new content is to be accessed and displayed; and
saving the new content and the layout template to a write-enabled destination server remote from the plurality of servers, the new content being saved in a format configured to be accessible in accordance with the access permissions and displayable in accordance with the display parameters when accessed.

17. The method recited in claim 16, wherein the editing application is a what-you-see-is-what-you-get (WYSIWYG) editor.

18. The method recited in claim 16, wherein the new content is formatted using one or more of Really Simple Syndication, Rich Site Summary, and Resource Description Framework Site Summary (RSS)

19. The method recited in claim 16, wherein the new content is displayed in the editing application and within the layout template when the new content is accessed.

20. The method recited in claim 16, wherein the new content is displayed in a browser when the new content is accessed.

21. A system, comprising:
a processor; and
a memory configured to store data associated with website content, the memory having logic stored thereon that, when executed by the processor, causes the processor to implement a remixing application configured to:
retrieve website content from a plurality of sources remote from the remixing application, wherein settings for the content prevent the remixing application and the processor from modifying the content at each of the plurality of sources;
create a modifiable copy of the retrieved content by combining, parsing and normalizing the retrieved content;
store the modifiable copy of the retrieved content in the memory;
remix the copy of the retrieved content by editing the copy of the retrieved content and augmenting the copy of the retrieved content with other content to generate new content;
determine settings for the new content, the settings including access permissions and display parameters specifying how the new content is to be accessed and displayed; and
publish the new content to a write-enabled destination server remote from the plurality of sources, so that the new content is accessible in accordance with the access permissions and displayable in accordance with the display parameters after it has been saved to the destination server.

22. The system of claim 21, wherein the remixing application further comprises a retrieval element configured to retrieve the content from the plurality of sources.

23. The system of claim 21, wherein the remixing application further comprises a publishing element configured to publish the new content to the destination server.

24. (canceled)

25. A system, comprising:
a processor; and
a memory configured to store content using a layout template, the memory having instructions stored thereon that, when executed by the processor, cause the processor to implement an editing application configured to:
present the layout template;
retrieve website content from a plurality of sources remote from the editing application, wherein settings for the content prevent the editing application and the processor from modifying the content at each of the plurality of sources;
create a modifiable copy of the retrieved content by combining, parsing and normalizing the retrieved content;
receive the modifiable copy of the retrieved content in the layout template, the layout template being configured to edit the received content;
display the received content within the layout template;
remix the received content to generate new content;
determine settings for the new content, the settings including access permissions and display parameters specifying how the new content is to be accessed and displayed; and
save the new content and the layout template to a write-enabled destination server remote from the plurality of sources, the new content being saved in a format configured to be accessible in accordance with the access permissions and displayable in accordance with the display parameters when accessed.

26. A non-transitory computer readable storage medium having instructions stored thereon that, when executed by a computer, cause the computer to implement a remixing application configured to:
retrieve website content from a plurality of sources remote from the computer, wherein settings for the content prevent the remixing application and the computer from modifying the content at each of the plurality of sources;
create a modifiable copy of the retrieved content by combining, parsing and normalizing the retrieved content;
store the modifiable copy of the retrieved content in the computer readable storage medium;
remix the copy of the retrieved content by editing the copy of the retrieved content and augmenting the copy of the retrieved content with other content to generate new content;
determine settings for the new content, the settings including access permissions and display parameters specifying how the new content is to be accessed and displayed; and
publish the new content to a write-enabled destination server remote from the plurality of sources, so that the new content is accessible in accordance with the access permissions and displayable in accordance with the display parameters after it has been saved to the destination server.

27. A non-transitory computer readable storage medium having instructions stored thereon that, when executed by a computer, cause the computer to implement an editing application, wherein the editing application is configured to:
present a layout template;
retrieve website content from a plurality of servers remote from the editing application, wherein settings for the content at the plurality of servers prevent the editing application and the computer from modifying the content at each of the plurality of servers;
create a modifiable copy of the retrieved content by combining, parsing and normalizing the retrieved content;
receive the modifiable copy of the retrieved content in the layout template, the layout template being configured to edit the received content;
display the received content within the layout template;
remix the received content to generate new content;
determine settings for the new content, the settings including access permissions and display parameters specifying how the new content is to be accessed and displayed; and
save the new content and the layout template to a write-enabled destination server remote from the plurality of servers, the new content being saved in a format configured to be accessible in accordance with the access permissions and displayable in accordance with the display parameters when accessed.
